(19) United States
(12) Patent Application Publication
(10) Pub. No.: US 2026/0299959 A1
(43) Pub. Date: Oct. 1, 2026

(54) Circuitry for Accelerating Processing of Artificial Intelligence Models

(71) Applicant: Numenta, Inc., Menlo Park, CA (US)

(72) Inventors: Robert Edward Liston, Menlo Park, CA (US); Subutai Ahmad, Palo Alto, CA (US)

(21) Appl. No.: 19/559,996

(22) Filed: Mar. 7, 2026

Related U.S. Application Data
(60) Provisional application No. 63/780,167, filed on Mar. 29, 2025.

(51) Int. Cl. G06F 9/38

(52) U.S. Cl. CPC G06F 9/3885

(57) ABSTRACT

Embodiments relate to enhancing operations associated with an artificial intelligence (AI) model by distributing accumulator operations across multiple parallel lanes of circuit pipelines. The incoming tensors are multiplied and then the multiplied values are sent to a subset of the parallel lanes. The multiplication operations take a shorter time than the subsequent accumulation operations. By distributing the accumulator operations to multiple parallel lanes, the incoming tensors are processed seamlessly without interruption despite the accumulation operations taking longer than the multiplication operations. Operations for comparing accumulated results are also partly distributed across parallel lanes so that the highest accumulated values and their indices may also be determined seamlessly. In this way, the AI model may be executed faster and more efficiently.

### CROSS-REFERENCE TO RELATED APPLICATIONS

The present application claims the benefit of U.S. Provisional Patent Application No. 63/780,167, filed on Mar. 29, 2025, which is incorporated by reference herein in its entirety.

### FIELD OF THE DISCLOSURE

The present disclosure relates to circuits for processing tensors, and more specifically to circuits for efficiently performing operations related to artificial intelligence models.

### BACKGROUND

The use of artificial neural networks (ANNs), or simply neural networks, includes a vast array of technologies. An ANN's complexity, in terms of the number of parameters, is growing exponentially at a faster rate than hardware performance. In many cases, an ANN may have a large number of parameters. Training and inference on these networks are bottlenecked by massive linear tensor operations, including multiplication and convolution. Many neural networks exhibit significant sparsity, where a substantial portion of tensor elements are zero or near-zero values. Consequently, a large amount of time and/or resources may be used for both ANN creation (e.g., training) and execution (e.g., inference), particularly when processing sparse tensors that contain irregular computation patterns and non-uniform memory access characteristics.

Computing systems that execute ANNs often involve extensive computing operations, including multiplication and accumulation on both dense and sparse tensors. For example, convolutional neural networks (CNNs) primarily use convolution between input data and kernel data, which can be decomposed into multiplication and accumulation operations. Processing sparse tensors presents significant challenges across various processor architectures, including central processing units (CPUs), graphics processing units (GPUs), and specialized accelerators. These challenges include irregular parallelization, load imbalance between processing threads, memory access irregularities, and difficulties in efficiently storing intermediate sparse data.

Using a generic processor and its main memory to instantiate and execute machine learning systems or models is relatively straightforward, as such systems can be instantiated with mere updates to code. However, conventional approaches for sparse tensor operations on the generic processor often consume significant processing bandwidth and increase overall power consumption, particularly when handling the irregular computation patterns inherent in sparse tensor algebra.

### SUMMARY

Embodiments relate to performing operations on tensors in a parallel manner so that incoming tensors are processed to generate an output. First operations are performed on a first tensor and a second tensor to generate first operation values. The first operation values are distributed in a deterministic manner to parallel processing circuits. Each of the parallel processing circuits performs second operations on a subset of the first operation values distributed to each of the parallel processing circuits.

In one or more embodiments, the first tensor includes a sparse activation tensor, the second tensor includes a sparse weight tensor, the first operations include multiplications and the second operations include accumulations.

In one or more embodiments, the number of the plurality of parallel processing circuits is larger than the number of the operation circuits.

In one or more embodiments, indices are received. The indices indicate elements of the second tensor from which the first operation values are derived. One of the parallel processing circuits is selected to perform the second operations on each of the first operation values according to each of the indices associated with each of the first operation values. The selected parallel processing circuit is distributed with each of the first operation values associated with each of the indices.

In one or more embodiments, each of the plurality of parallel processing circuits includes a buffer, a manager circuit, and a storage circuit. The buffer stores a subset of the first operation values distributed to the parallel processing circuit. The manager circuit reads the subset of the first operation values from the buffer, and performs the second operations. The storage circuit stores an operation table that stores the second operation values derived from the subset of the first operation values associated with the same index.

In one or more embodiments, the manager circuit determines if the operation table has space to accommodate an additional second operation value. If the operation table has space, an entry is instantiated in the operation table to store the additional second operation value. If the operation table lacks space, storage of the additional second operation value in the operation table is skipped.

In one or more embodiments, the storage circuit further stores a hash table that stores indices associated with the second operation values as its keys.

In one or more embodiments, the globally highest second operation value of the second operation values in the parallel processing circuits is determined in a first comparison cycle. The globally highest second operation value is cleared from the plurality of parallel processing circuits. The next globally highest second operation value of the second operation values is determined in a second comparison cycle after clearing the first globally highest second operation value.

In one or more embodiments, the locally highest second operation values in each of the parallel processing circuits are determined. Then, the locally highest second operation values are compared to determine the globally highest second operation value and the next globally highest second operation value.

In one or more embodiments, a sparse tensor in a compressed format including a predetermined number of tuples is generated. The tuples include a predetermined number of globally highest second values and their indices.

In one or more embodiments, collisions of assigning two or more first operation values concurrently processed by the plurality of operation circuits to the same one of the parallel processing circuits are resolved by differing times at which the two or more first operation values are sent to the same one of the parallel processing circuits.

### BRIEF DESCRIPTION OF THE DRAWINGS

The teachings of the embodiments of the present invention can be readily understood by considering the following detailed description in conjunction with the accompanying drawings.

Figure (FIG. 1A is a conceptual diagram illustrating an example architecture of a neural network, according to an embodiment.

FIG. 1B is a block diagram illustrating an example operation in the neural network, according to an embodiment.

FIG. 2 is a diagram illustrating the concept of sparsity in a neural network, according to an embodiment.

FIG. 3 is a flowchart illustrating processing a sparse activation tensor and a sparse weight tensor, according to an embodiment.

FIG. 4A is a diagram illustrating a sparse weight tensor, according to an embodiment.

FIG. 4B is a diagram illustrating weights of rows in a sparse tensor that are sorted and filtered, according to an embodiment.

FIG. 5 is a block diagram of a computing device, according to an embodiment.

FIGS. 6A and 6B are block diagrams illustrating interactions with processing circuitry and other circuits, according to embodiments.

FIG. 7 is a block diagram illustrating a multiply-accumulate-sort (MAS) circuit, according to an embodiment.

FIG. 8 is a block diagram illustrating a distributor circuit of the MAS circuit, according to an embodiment.

FIG. 9 is a block diagram of first and second selection circuits, according to an embodiment.

FIG. 10 is a block diagram of a sorting circuit of the MAS circuit, according to an embodiment.

FIG. 11 is a block diagram of a comparator tree circuit in the sorting circuit of FIG. 10, according to an embodiment.

FIG. 12 is a flowchart illustrating the processes of the MAS circuit, according to one embodiment.

### DETAILED DESCRIPTION OF EMBODIMENTS

In the following description of embodiments, numerous specific details are set forth in order to provide a more thorough understanding. However, note that the present invention may be practiced without one or more of these specific details. In other instances, well-known features have not been described in detail to avoid unnecessarily complicating the description.

A preferred embodiment is now described with reference to the figures where like reference numbers indicate identical or functionally similar elements. Also, in the figures, the left-most digit of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to the desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities, such as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. A computer-readable medium is a non-transitory medium that does not include propagation signals and transient waves. Furthermore, the computers referred to in the specification may include a single processor or may be architectures employing multiple processor designs for increased computing capability. Various embodiments described may also be implemented as field-programmable gate arrays (FPGAs), which include hardware programmable devices that accept programming commands to execute the processing of input data.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, embodiments are not described with reference to any particular programming language. It will be appreciated that a variety of programming languages may be used to implement the teachings as described herein, and any references below to specific languages are provided for disclosure of enablement and best mode of the embodiments.

In addition, the language used in the specification has been principally selected for readability and instructional purposes, and may not have been selected to delineate or circumscribe the inventive subject matter.

Embodiments relate to enhancing operations associated with an artificial intelligence (AI) model by distributing accumulator operations across multiple parallel lanes of circuit pipelines. The incoming tensors are multiplied and then the multiplied values are sent to a subset of the parallel lanes. The multiplication operations take a shorter time than subsequent accumulation operations. By distributing the accumulator operations to multiple parallel lanes, the incoming tensors are processed seamlessly without interruption despite the accumulation operations taking longer than the multiplication operations. Operations for comparing accumulated results are also partly distributed across parallel lanes so that the highest accumulated values and their indices may also be determined seamlessly. In this way, the AI model may be executed faster and more efficiently.

### Example Sparse Neural Network

A sparse tensor has a large number of elements that are zero. The degree of sparsity for a sparse tensor may vary depending on embodiments. In one embodiment, the number of non-zero active values in a tensor is fewer than 50% to be considered a sparse tensor. In one embodiment, the number of active values in a tensor is fewer than 40% to be considered a sparse tensor. In one embodiment, the number of active values in a tensor is fewer than 30% to be considered a sparse tensor. In one embodiment, the number of active values in a tensor is fewer than 20% to be considered a sparse tensor while in others, the number of active values in a tensor is fewer than 15%, 10%, 5%, 4%, 3%, 2%, 1%, 0.8%, 0.5%, 0.2%, 0.1% or 0.01% to be considered a sparse tensor.

If many or most of the elements are zero, many or most of the intermediate products of a vector dot product or a matrix multiplication operation will be zero. Taking the example of a matrix-matrix multiplication, as the sparsity of both matrices increases, the number of non-zero intermediate products decreases exponentially. Hence, the amount of computation for performing a matrix multiplication on two sparse matrices may be orders of magnitude smaller if operands of zero are skipped, thereby reducing the processing time, the amount of data manipulation, arithmetic execution time and energy consumption.

A sparse tensor may be represented in compressed formats to balance memory saving and speedy access. Such formats include, but are not limited to, Compressed Sparse Row (CSR), Compressed Sparse Column (CSC), Coordinated List (COO) and various block-structured formats. Some of these formats reduce memory waste but result in increased overhead, memory traffic and slower access speed while others compromise memory reduction in favor of reduced overhead, memory traffic and higher access speed.

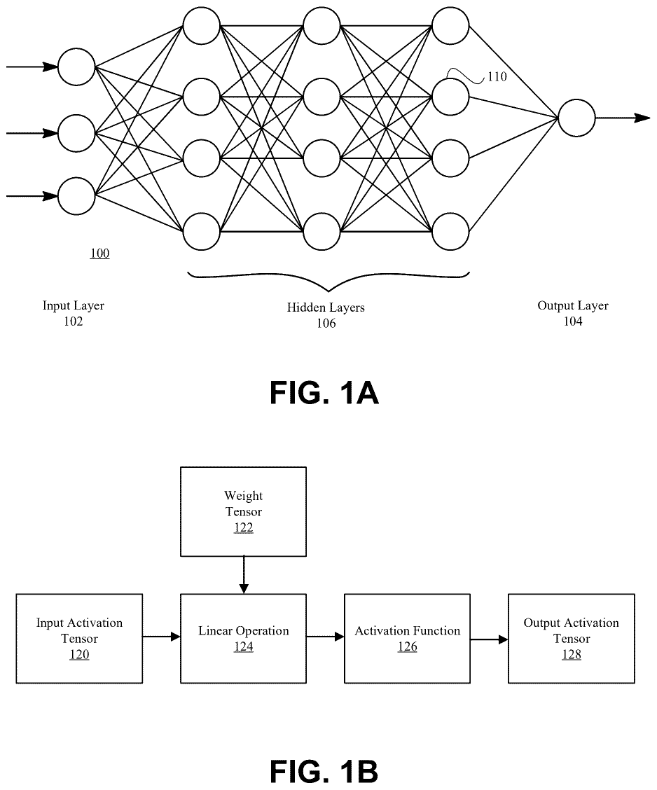

FIG. 1A is a conceptual diagram illustrating an example architecture of a neural network 100, according to an embodiment. The illustrated neural network 100 shows a generic structure of a neural network. Neural network 100 may represent different types of neural networks, including convolutional neural networks (CNNs), recurrent neural networks (RNNs), autoencoders, and long short term memory (LSTM). In various embodiments, customized changes may be made to this general structure. Neural network 100 may also be a hierarchical temporal memory system as described, for example, in U.S. Patent Application Publication No. 2020/0097857, published on May 26, 2020, which is incorporated herein by reference in its entirety.

Neural network 100 includes an input layer 102, an output layer 104 and one or more hidden layers 106. Input layer 102 is the first layer of neural network 100. Input layer 102 receives input data, such as image data, speech data, text, etc. Output layer 104 is the last layer of neural network 100. Output layer 104 may generate inferences in the form of classifications, probabilities and generated contents. Neural network 100 may include any number of hidden layers 106. Hidden layers 106 are intermediate layers in neural network 100 that perform various operations. Neural network 100 may include additional or fewer layers than the example shown in FIG. 1A. Each layer may include one or more nodes 110. The number of nodes in each layer in the neural network 100 shown in FIG. 1A is an example only. A node 110 may be associated with certain weights and activation functions. In various embodiments, the nodes 110 in neural network 100 may be fully connected or partially connected.

Each node 110 in neural network 100 may be associated with different operations. For example, in a simple form, neural network 100 may have nodes, each associated with a set of weights and an activation function. In another embodiment, neural network 100 may be an example of a convolutional neural network (CNN). In this example CNN, nodes 110 in one layer may be associated with convolution operations with kernels as weights that are adjustable in the training process. Nodes 110 in another layer may be associated with spatial pooling operations. In yet another embodiment, neural network 100 may be a recurrent neural network (RNN) whose nodes may be associated with more complicated structures such as loops and gates. In neural network 100, each node may represent a different structure and have different weight values and a different activation function.

FIG. 1B is a block diagram illustrating an example operation of a node 110 in neural network 100, according to an embodiment. A node 110 may receive an input activation tensor 120, which can be an N-dimensional tensor, where N may be greater than or equal to one. Input activation tensor 120 may be the input data of neural network 100 if node 110 is in the input layer 102. Input activation tensor 120 may also be the output of another node in the preceding layer. Node 110 may apply a weight tensor 122 to input activation tensor 120 in a linear operation 124, such as addition, scaling, biasing, tensor multiplication, and convolution in the case of a CNN. The result of linear operation 124 may be processed by activation function 126. The activation function may be, for example, a sparsity activation function such as a k-WTA function, a step function, a sigmoid function, a hyperbolic tangent function (tanh), and rectified linear unit functions (ReLU). The result of the activation function is an output activation tensor 128 that is sent to a subsequent layer of neural network 100. The subsequent node uses output activation tensor 128 as the input activation tensor 120.

In various embodiments, a wide variety of machine learning techniques may be used in training neural network 100. Neural network 100 may be associated with an objective function (also commonly referred to as a loss function), which generates a metric value that describes the objective goal of the training process. The training may intend to reduce the error rate of the model in generating predictions. In such a case, the objective function may monitor the error rate of neural network 100. For example, in object recognition (e.g., object detection and classification), the objective function of neural network 100 may be the training error rate in classifying objects in a training set. Other forms of objective functions may also be used. In various embodiments, the error rate may be measured as cross-entropy loss, L1 loss (e.g., the sum of absolute differences between the predicted values and the actual value), L2 loss (e.g., the sum of squared distances) or their combinations.

The weights and coefficients in the activation functions of neural network 100 may be adjusted by training and also be constrained by sparsity and structural requirements. Training of neural network 100 may include forward propagation and backpropagation. In forward propagation, neural network 100 performs the computation in the forward direction based on outputs of a preceding layer. The operation of a node 110 may be defined by one or more functions, such as linear operation 124 and non-linear activation function 126. The functions that define the operation of a node 110 may include various computation operations such as convolution of data with one or more kernels, pooling, recurrent loop in RNN, various gates in LSTM, etc. The functions may also include an activation function that adjusts the output of the node.

Each of the functions in neural network 100 may be associated with different weights (e.g., kernel coefficients) that are adjustable during training. After an input is provided to neural network 100 and passes through neural network 100 in the forward direction, the results may be compared to the training labels or other values in the training set to determine the neural network's performance. The process of prediction or generation may be repeated for other samples in the training sets to compute the overall value of the objective function in a particular training round. In turn, neural network 100 performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., neural network 100 has converged) or after a predetermined number of rounds for a particular set of training samples. The trained neural network 100 can be used for making inferences/generation or another suitable task for which the model is trained.

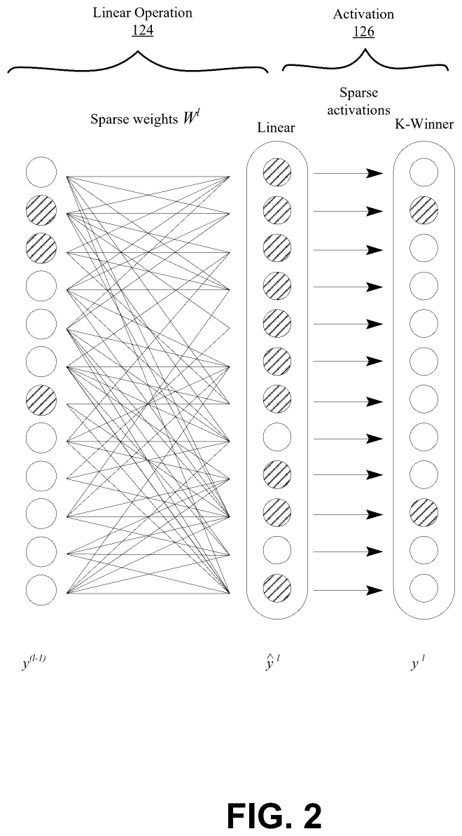

FIG. 2 illustrates the concept of sparsity in a neural network 100, according to one embodiment. One or both of the input activation tensor 120 and the weight tensor 122 may be sparse. A circle in FIG. 2 represents an element in a tensor where the shaded ones represent elements that have non-zero values, and the empty ones represent elements that have a zero value. Specifically, in a neural network 100 with L hidden layers, the notation y^{l} denotes output activation tensor 128 from layer l and y^{l-1} denotes the output activation tensor 128 in the preceding layer l−1 or the input activation tensor 120 of layer l. W^{l} and u^{l} represent respectively weight tensor 122 and biases for each node. In a neural network node 110 that has a dense process tensor W^{l}, the feed-forward outputs are calculated as follows:

$${\hat{y}}^{l} = {W}^{l} \cdot {y}^{l - 1} + {u}^{l} \qquad Equation 1$$

$${y}^{l} = f ( {\hat{y}}^{l} ) \qquad Equation 2$$

where ƒ is any activation function, such as a sparsity function, tanh or ReLU; and ŷ^{l} is the output of the linear operation before an activation function is applied.

### Example Processes for Efficient Sparse Tensor Operations

One way to efficiently process sparse tensors in neural networks is to prioritize allocation of memory space for storing processed outputs based on their likely importance. In one or more embodiments, the importance is represented by the magnitudes of the output values where the higher magnitude represents a higher importance. When a k-WTA function is used as the activation function to generate the output activation tensor, only a subset of the highest output values is retained whereas the remaining output values are set to zero values. Since the output elements with the highest magnitudes are retained in the output activation whereas the remaining output elements are set to zero, output elements likely to yield higher values may be prioritized for storing when the available memory space is limited. The memory space may be taken up by accumulators for storing intermediate and final output values, and hence, the total number of the accumulators may be preset to keep the memory usage within a desired limit. For this purpose, the sparse input tensor and the sparse weight tensor may be sorted based on their magnitude, and then earlier elements in the two tensors are given priority in terms of processing while processing of subsequent elements in the two tensors may be skipped when the allocated memory space is filled up.

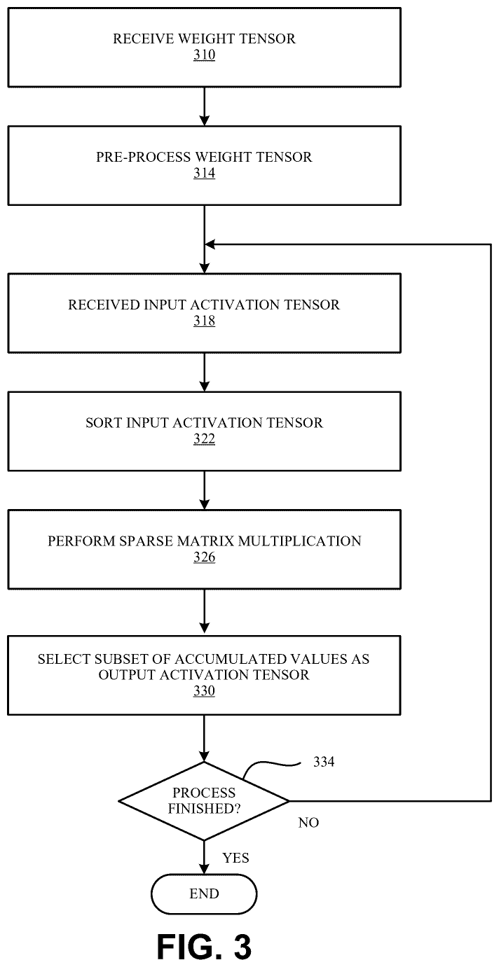

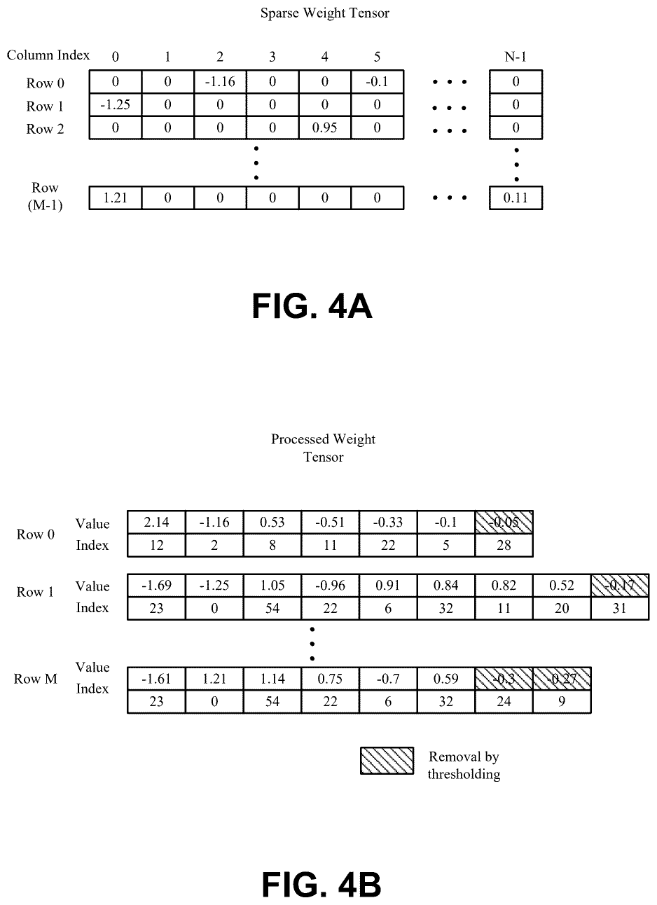

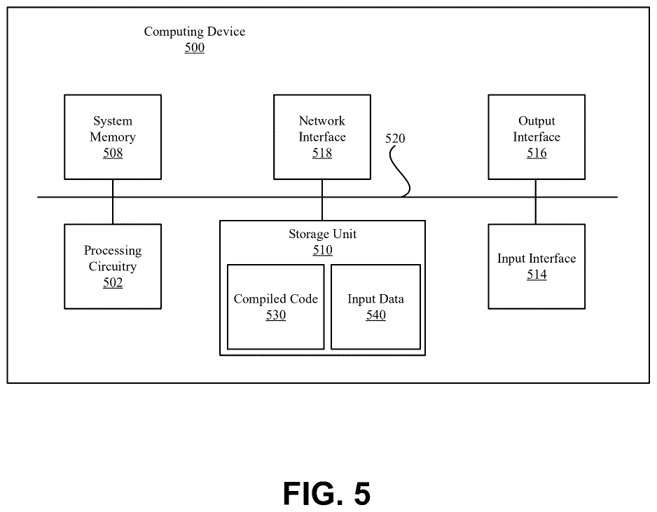

FIG. 3 is a flowchart illustrating processing a sparse activation tensor and a sparse weight tensor in a neural network, according to an embodiment. The processing of the tensors in FIG. 3 may include a convolution operation followed by selecting a subset of the convolution results. In a neural network, a weight tensor remains the same during its runtime. After the weight tensor is received 310, the weight tensor is pre-processed 314 to remove zero-valued elements and sort its elements in a descending order of magnitude with or without filtering as described below with reference to FIGS. 4A and 4B. Such preprocessing of the weight tensor may be performed offline during a compilation process before executing the neural network for inference or content generation.

During the runtime of the neural network, the input activation tensor is received 318 at a node or a layer of the neural network. To facilitate the prioritizing of the processing of elements in the input activation that are likely to yield important outputs, elements in the input activation tensor may also be sorted 322 in a descending order of magnitude. After or during sorting, the elements of the activation tensor with values that are below a threshold may also be filtered.

Then the sparse matrix multiplication is performed 326 between the input activation tensor and the weight tensor. Pseudo-code for performing the sparse matrix multiplication is provided below:

| | |
|---|---|
| 100 | def sparse_matmul(activations, weights, kacc): |
| 101 | |
| 102 | acc = zeros(kacc) |
| 103 | ht = { } |
| 104 | max_offset = 0 |
| 105 | for (a, i) in activations: |
| 106 | for (w, j) in weights [i]: |
| 107 | if j in ht: |
| 108 | v = w * a |
| 109 | offset = ht[j] |
| 110 | acc[offset] += v |
| 111 | elif len(ht) < kacc: |
| 112 | v = w * a |
| 113 | ht[j] = max_offset |
| 114 | acc[max_offset] = v |
| 115 | max_offset += 1 |
| 116 | |
| 117 | return ht, acc |

In this pseudo code, the preprocessed activation tensor a is represented in a dense data structure that contains the activations and their indices where the activations are sorted by magnitude. For example, the preprocessed activation tensor may be represented as a list of tuples such as [(1.11,5), (−0.6, 11), (0.49,9), (−0.39, 0)] where the first element of the tuple represents an activation, and the second element of the tuple represents a row index of the activation. The iterator on line 105 iterates through each of the sorted activations and their indices in sequence. The preprocessed weight tensor w is also represented in a data structure that contains the weight values and their indices of each row of weight values where the weights are sorted by magnitude. The preprocessed weight tensor may be represented as a list of tuples where the first element of the tuple represents the weight value, and the second element of the tuple represents a column index. The iterator on line 106 iterates through the weight values and indices for row i of the weight tensor. kacc is an integer representing the maximum number of elements in an accumulator array.

For a weight in column j of the weight tensor, the offset of its corresponding accumulator in the accumulator array is determined by a hash function, as shown in line 109. The pseudo code returns a hash table ht and the accumulator array acc. The keys of the hash table are indices of the non-zero output activations, and the entries of the hash table ht are offset locations in the accumulator table that contain the values of accumulators that sum the multiplied products of the corresponding weights and activations.

According to the pseudo code, the largest values of both weight elements and activation elements are processed first since both the activation tensors and the weight tensors are sorted in the order of descending magnitude. When all the available accumulators in the accumulator array are used up to accumulate the products associated with weights of earlier tuples, no further accumulator is associated with products resulting from subsequent weights of later tuples.

After the sparse matrix multiplication is complete, a subset of accumulated values in the accumulators is selected 330 to include it in an output activation tensor. Since both activations and weights were previously sorted by their magnitude, the accumulators corresponding to the largest values of both weights and activations are likely to contain the highest accumulated values. If the number of top kO accumulated values to be selected using the k-WTA function is significantly less than kacc (for example, kacc=4*k^{O}), then the subset of accumulator values selected from kacc accumulators would approximate the result of performing the k-WTA function on all products of the activations and the weights. If kacc is equal to the number of columns in the weight matrix, the final result would include exactly the same result as performing k-WTA on full matrix multiplication output results of the activation tensor and the weight tensor. In one or more embodiments, the number of accumulator elements kacc may be set to tune the accuracy of the k-WTA operation to an acceptable level.

After selecting the output activation, the process proceeds to determine 334 if all the input activation tensor is processed. If there are remaining input activation tensors to process, the process returns to receive 318 the next input activation tensor and repeats the subsequent operations.

The processing according to the pseudo code is advantageous, among other reasons, because (i) the number of multiplications is reduced, (ii) the number of floating-point comparisons is reduced, and (iii) the memory bandwidth associated with the accumulators is reduced. First, the calculation of w*a is only performed to the extent the calculation is relevant to producing a subset of output indices, and hence, the process reduces the number of computations. In fact, after the hash table is filled with the maximum number of entries (kacc), line 111 will always return false and none of the operations in lines 112-115 are executed. For example, at 95% output sparsity (if k° is 5% of the number of weight columns) and kacc is 4*k°, then on average lines 112-115 are executed only 20% of the time. Further, the number of accumulators kacc may be set to store only a subset of accumulated values. Such a reduced number of accumulators also enables the k-WTA function to be performed with fewer floating-point comparisons between the accumulated values. The process also reduces memory bandwidth because fewer accumulators relative to the result of a full matrix multiplication are accessed. The number of accumulators to be stored may be reduced so that all or most of the accumulators fit into a cache memory (e.g., L1 cache). By using the cache memory, the speed of accessing the accumulators and subsequent processing using the values stored in the accumulators would be increased significantly relative to storing the accumulators in a system memory.

FIG. 4A is a diagram illustrating a sparse weight tensor, according to an embodiment. In this example, the sparse weight tensor has N columns and M rows. Most of the elements in the sparse weight tensors are zero while only selected elements have non-zero values. During the pre-processing of the sparse weight tensors, each row of weights is sorted in a descending order of magnitude, and stored with their column indices in the original sparse weight tensor, as shown in FIG. 4B. For example, in the first row (row 0) of the processed sparse weight tensor, an element in column 12 has the largest magnitude of 2.14 followed by an element in column 2 that has the next largest magnitude of −1.16. These values are stored with their corresponding column indices in the original sparse weight tensor (shown in FIG. 4A).

In FIG. 4A, a threshold may further be applied to each row to filter out the weights having absolute values below a threshold. For example, in the first row (row 0) of the preprocessed sparse weight tensor, column 28 may have a magnitude below a threshold of 0.09, and hence, is discarded. In some embodiments, different rows of weights are filtered using different thresholds. Such thresholds may be set in various ways. One example of determining the thresholds is by computing statistics such as a mean magnitude and standard deviation of magnitude of sorted values for each row. Then, a row-specific threshold is determined based on the statistics. For example, any weight values whose magnitude is below the mean minus three times the standard deviation may be filtered out. Alternatively, these thresholds may be determined iteratively by using test input activations to generate output activations, and comparing the output activations with accurate output activations for accuracy. The thresholds may be adjusted and then the resulting accuracy determined in an iterative manner to constrain the accuracy to an acceptable range. In other embodiments, the same threshold is applied across different rows of the weight tensor.

The activation tensor may be pre-processed to sort elements in each of its columns in a descending order of magnitude. Filtering may also be performed per each column to remove activations below a threshold. As in the preprocessing of the weight tensor, the same or different thresholds may be applied to each column of activations or the same threshold may be applied to all columns of activations.

In some embodiments, the filtering of weights or activations based on thresholds may be omitted and only sorting may be performed during the preprocessing of one or both the weight tensor and the activation tensor.

Although the process is described with reference to the pseudo code using the magnitude of the elements to sort the weight tensor and the input activation tensor, other criteria may be used for sorting. For example, instead of sorting the elements based on the magnitude of elements, a saliency metric for each weight may be used to sort elements in a row of the weight tensor or a column of the input activation tensor. An example saliency metric may be determined by the following equation:

$$average ( abs ( input\_activation \_i * weight\_ij ) ) \qquad Equation ( 1 )$$

where a test input activation tensor is used for each weight. In another example, the saliency metric may be computed using the following equation:

$$abs ( prob ( column j is a winner ) * weight\_ij ) \qquad Equation ( 2 )$$

where prob (column j is a winner) represents the duty cycle of column j after a subsequent k-WTA operation. In some embodiments, the elements may be sorted using a combination of magnitude and a saliency metric.

Although the process was described above primarily with reference to cases where both the weight tensor and the input activation tensor are sparse, the same principle may be applied to cases where only one of the tensors is sparse.

### Example Computing Device Architecture

The process associated with the pseudo code or its modified versions may be executed on a computing device with dedicated hardware components. Such dedicated hardware components may enable processors with conventional or new architectures to perform operations associated with a neural network in a more efficient and expedient manner. In some embodiments, the processors may perform sparse matrix multiplications with the assistance of the dedicated hardware components while performing other computing operations in a conventional manner.

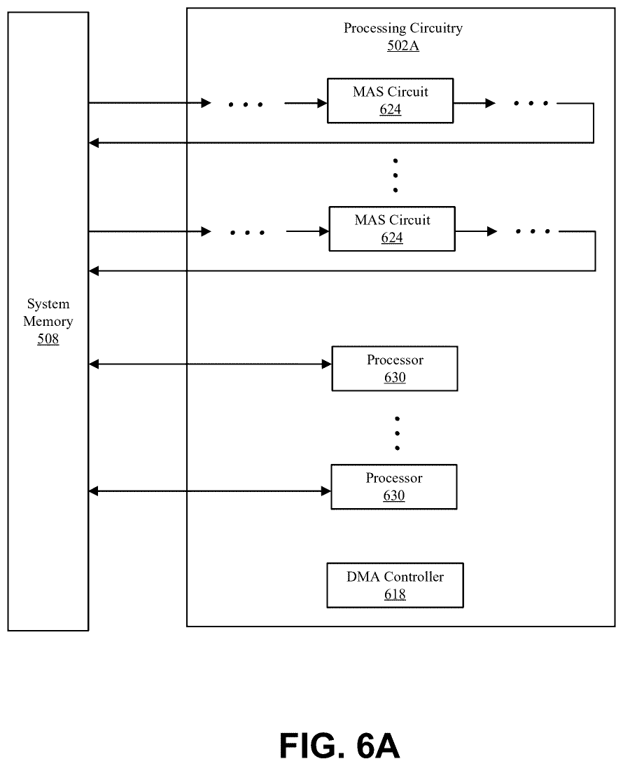

FIG. 5 is a block diagram of an example computing device 500 for processing one or more sparse neural networks, according to an embodiment. Computing device 500 may be a server computer, a personal computer, a portable electronic device, a wearable electronic device (e.g., a smartwatch), an IoT device (e.g., a sensor), a smart/connected appliance (e.g., a refrigerator), a dongle, a device in edge computing, a device with limited processing power, etc. Computing device 500 may include, among other components, processing circuitry 502, system memory 508, a storage unit 510, an input interface 514, an output interface 516, a network interface 518, and a bus 520 connecting these components. In various embodiments, computing device 500 may include additional, fewer or different components.

Some of the components in this disclosure may at times be described in a singular form while other components may be described in a plural form, various components described in any system may include one or more copies of the components.

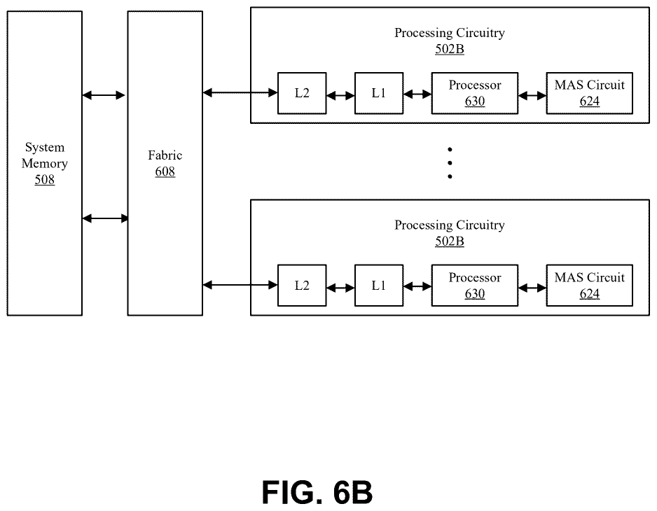

Processing circuitry 502 is hardware that performs computing operations including sparse tensor operations. Processing circuitry 502 may include one or more processors such as central processing units (CPUs), neural processing units (NPUs), field-programmable gate arrays (FPGAs), and digital signal processors (DSPs) along with one or more sparse processing circuits. With the assistance of the sparse processing circuits, the one or more processors in processing circuitry 502 may perform sparse tensor operations more efficiently and expediently. Processing circuitry 502 may also perform operations other than sparse tensor operations including, but not limited to, dense tensor operations, managing resources of computing device 500, and execution of various applications. Example architectures of processing circuitry 502 are described below in detail with reference to FIGS. 6A and 6B.

System memory 508 includes circuitry for storing instructions executed by processing circuitry 502 and data processed by processing circuitry 502. System memory 508 may take the form of any type of memory structure including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. System memory 508 may be part of a memory system that further includes a memory controller and one or more levels of cache memory.

Storage unit 510 may be a persistent storage for storing data and software applications in a non-volatile manner. Storage unit 510 may take the form of read-only memory (ROM), a hard drive, flash memory, or another type of non-volatile memory device. Storage unit 510 stores the operating system of the computing device 500, various sets of compiled code 530 and input data 540. Compiled code 530, when executed by processing circuitry 502, may instantiate and execute various applications including machine learning models including neural networks. Machine learning models instantiated by compiled code 530 may include different types of algorithms for making inferences based on the training of the models. Examples of machine learning models include regression models, random forest models, support vector machines (SVMs) such as kernel SVMs, and artificial neural networks (ANNs) such as convolutional neural networks (CNNs), recurrent neural networks (RNNs), autoencoders, long short-term memory (LSTM), and reinforcement learning (RL) models.

Input interface 514 receives data from external sources such as a database, the Internet or sensors. Output interface 516 is a component for providing the result of computations in various forms (e.g., image or audio signals). Computing device 500 may include various types of input or output interfaces, such as displays, keyboards, cameras, microphones, speakers, antennas, fingerprint sensors, touch sensors, and other measurement sensors. Input interface 514 may directly work with a machine learning model to perform various functions. Output interface 516 may be in communication with humans, robotic or artificial intelligence (AI) agents or other computing devices.

Network interface 518 enables computing device 500 to communicate with other computing devices via a network. The networks may include, but are not limited to, Local Area Networks (LANs) (e.g., an Ethernet or corporate network) and Wide Area Networks (WANs). When multiple nodes/layers or components of a machine learning model are embodied in multiple computing devices, information associated with various processes in the machine learning model may be communicated between computing devices via the network interface 518. Although only a single computing device is illustrated in FIG. 5, the functions and operations of computing device 500 may be distributed across multiple computing devices communicating over network interface 518.

FIG. 6A is an interaction diagram showing interaction between processing circuitry 502A and system memory 508, according to one embodiment. The processing circuitry 502A includes, among other components, multiple multiply-accumulate-sort circuits (MAS) 624, processors 630, and a direct memory access (DMA) controller 618. Processing circuitry 502A may include other components such as cache memory and an internal bus that connects its components. In some embodiments, MAS 624 may communicate with system memory 508 via one or more processors 630.

MAS circuit 624 is a specialized circuit that performs mathematical operations in an efficient manner by parallel processing. MAS circuit 624 receives tensors (e.g., activation tensor and weight tensor), performs mathematical operations in parallel using multiple lanes of circuit pipelines, and sends out an output tensor including a subset of selected results from the mathematical operations. These input tensors to MAS circuit 624 and the output tensor from MAS circuit 624 may be streamed using a streaming protocol such as AXI4-Stream protocol.

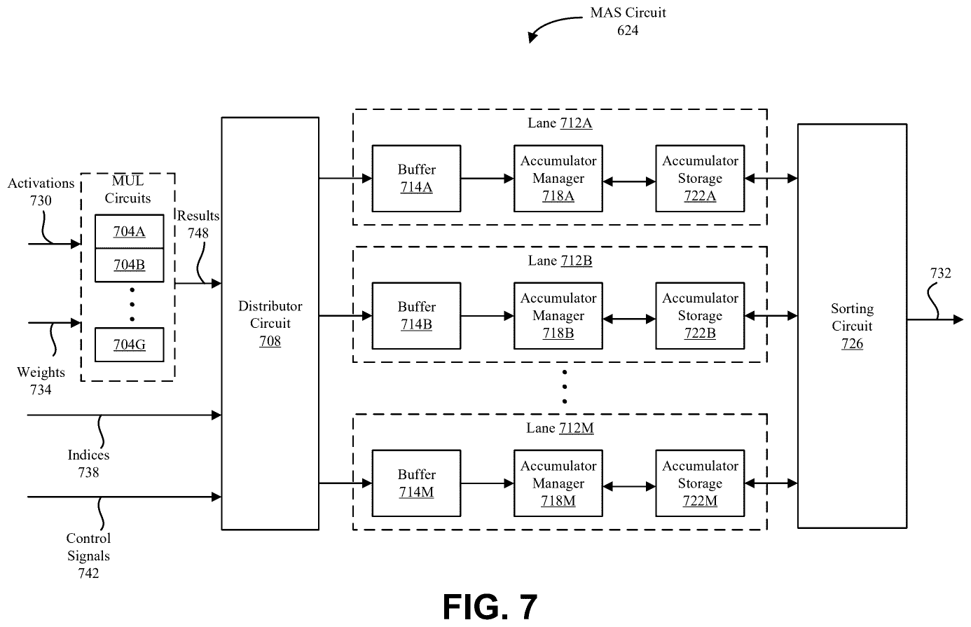

In one or more embodiments, MAS circuit 624 is designed to process sparse tensors (e.g., one or more of the activation tensor and the weight tensor) in an efficient manner. At least one of the input tensors may be sparse, and may be represented in a compressed sparse tensor format. The output tensor may also be sparse, and may be represented in a compressed sparse tensor format. The mathematical operations may include, among others, multiple-accumulate operations and sorting operations. In some embodiments, MAS circuit 624 may itself execute single instruction, multiple data (SIMD) instructions associated with sparse tensor operations so that MAS circuit 624 concurrently receives and processes multiple tensor values. In other embodiments, the SIMD instructions are decoded by processors 630, which control MAS circuit 624 to perform mathematical operations on multiple tensor values concurrently. Each MAS circuit 624 may be associated with one or more of processors 630. The details of MAS circuit 502A are described below in detail with reference to FIG. 7.

Processor 630 is a circuit that executes instructions to perform various operations. Processor 630 may be embodied, for example, as central processing unit (CPU), graphics processing unit (GPU), field-programmable gate array (FPGA), neural processing unit (NPU), application-specific integrated circuit (ASIC) or a combination thereof. The number of processors 630 included in processing circuitry 502A may coincide with or differ from the number of MAS circuits in processing circuitry 502A.

DMA controller 618 is a circuit that enables processing circuitry 502A to manage data access via system memory 508. DMA controller 618 facilitates the transfer of data between processing circuitry 502A and system memory 508 with only limited intervention or no intervention from processors 630. In some embodiments, DMA controller 618 enables MAS circuits 624 to access system memory 508 directly.

FIG. 6B is a block diagram of processing circuitry 502B that uses remote procedure call (RPC), according to another embodiment. In the embodiment of FIG. 6B, the processing circuitry 502B communicates with system memory 508 via fabric 608 so that process calls may be made to different processing circuits 502B using streaming packetized data. Fabric 608 may be embodied as a common network fabric such as Ethernet or Compute Express Link (CXL). Each processing circuitry 502B or a subset instances of processing circuitry 502B may be included in a different physical device.

Each processing circuitry 502B may include, among other components, L1 cache, L2 cache, processor 630 and MAS circuit 624. MAS circuit 624 may access data in system memory 508 via processor 630 and fabric 608. Although each processing circuit 502B is illustrated as including only one processor 630 and MAS circuit 624, two or more processors 630 and MAS circuits 624 may be included in processing circuitry 502B.

The circuits of architecture illustrated in FIGS. 6A and 6B share the same system memory 508. However, in other embodiments, different instances of processing circuitry may be assigned different memory devices to access different data sets. Embodiments of FIGS. 6A and 6B are merely examples, and architectures with different arrangements of MAS circuits and processors may also be used.

### Example Multiply-Accumulate-Sort Circuit

FIG. 7 is a block diagram illustrating MAS circuit 624, according to one embodiment. MAS circuit 624 may perform both multiply-accumulate operations on sparse tensors and then perform top-k sorting on the results of the multiply-accumulate operations. For this purpose, MAS circuit 624 may receive sparse tensors (e.g., an activation tensor and a weight tensor) or portions thereof, and select a subset of accumulated results as its output 732. MAS circuit 624 may also receive column indices of the weight tensor as indices 738 in a compressed sparse format such as CSR, CSC and COO. In such formats, indices of weights that have zero value are omitted, and therefore, the sparse tensors are represented in a compact format. The subset of accumulated results may be the highest accumulated results (top-k) or their approximation. Output 732 may be sent to processor 630 or other circuits for further processing associated with an AI model.

For this purpose, MAS circuit 624 includes multiple stages of circuits. MAS circuit 624 may include, among other components, multiplication circuits 704A through 704G (also referred to collectively as “multiplication circuits 704” or individually as “multiplication circuit 704”), distribution circuit 708, lanes 712A through 712M (also referred to collectively as “lanes 712” or individually as “lane 712”), and a sorting circuit 726. Two or more of these components may be combined into a single component or their functions performed by processor 630 or other circuits that also perform other functions. To enable the streaming multiply-accumulate operations on activations 730 and weights 734, the number of lanes 712 is typically larger than the number of multiplier circuits 704. In this way, the overall operation of MAS circuit 624 is not stalled by the accumulate operations that take more processing cycles compared to the multiplication operations to complete. In one or more embodiments, MAS circuit 624 receives one or both of activations 730 and weights 734 and their indices, in a sparse compressed format.

Each of multiplication circuits 704 receives a pair of activation and weight, and performs multiplications on these values. As a result, multiplication circuits 704 produce operation results (e.g., multiplied results 748) for sending to distributor circuit 708. In some embodiments, the number of activation-weight pairs concurrently processed by MAS circuit 624 is the same as a lane count of a SIMD instruction associated with its operation. Although the primary operation of multiplication circuits 704 is to perform multiplication, these circuits may perform other operations such as Boolean function and two input ternary function. To perform such other operations, multiplication circuit 704 may include other circuit components such as AND gates. Alternatively, multiplication circuits 704 may be replaced with circuits that perform other operations that are followed by accumulation operations.

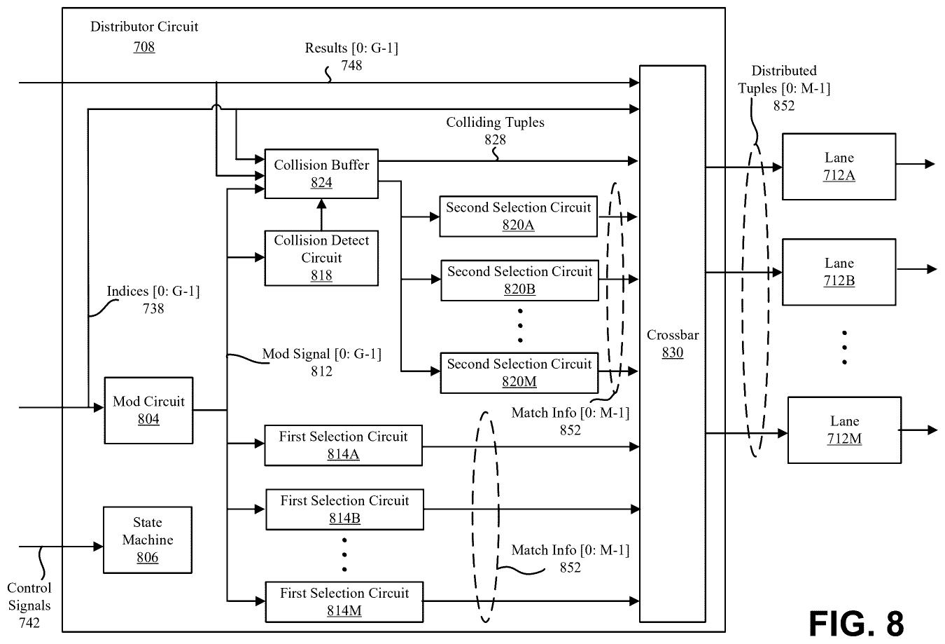

Distributor circuit 708 receives multiplied results 748, and distributes them across lanes 712 in a deterministic manner. In some embodiments, distributor circuit 708 may receive tuples of multiplied results 748 and sparse weight indices 738 associated with weights 734. The sparse weight indices 738 may then be used to determine which lanes 712 the corresponding tuples should be distributed to. For this purpose, functions such as modulo-M may be applied to the sparse weight indices 738 to determine the lanes 712. Then, distributor circuit 708 distributes the tuples to the determined lanes 712. Distributor circuit 708 also receives control signal 742 from other circuits or sources (e.g., processor 630 or DMA controller 618) to control the operations of distributor circuit 708. The details of distributor circuit 708 are described in detail with reference to FIG. 8.

Lanes 712 are parallel processing circuits that operate in parallel to process tuples of multiple results 748 and sparse weight indices 738, as distributed by distributor circuit 708. Each of the lanes 712 buffers the tuples received from distributor circuit 708 and performs accumulation operations on the tuples. For this purpose, each of lanes 712 includes buffer 714, accumulator manager 718, and accumulator storage 722. Buffer 714 is a circuit that buffers the received tuples and passes them onto accumulator manager 718. Since the speed at which tuples are received by lane 712 may temporarily exceed the speed at which these tuples are processed by downstream components of lane 712, buffer 714 may store the received tuples. Buffer 714 may be embodied as a First In, First Out (FIFO) buffer.

Accumulator manager 718 is hardware, software, firmware or a combination thereof for managing accumulators in accumulator storage 722. Accumulator manager 718 performs the operations of managing an accumulator table and a hash table. Specifically, when an entry for the multiplied result of the received tuple is not present in the accumulator table, accumulator manager 718 checks if there is an available empty slot in the accumulator table. Whether there is an entry for the multiplied result that is already present in the accumulator table may be determined by searching the hash table for the weight index of the tuple as its key. If there is an empty slot in the accumulator table, accumulator manager 718 stores the multiplied result in the empty slot and updates the hash table to store, as a key, the hash value of the index of the weight in the received tuple. If there is no empty slot available, the received tuple is discarded without storing the tuple in the accumulator table. If there is already an entry for the tuple previously instantiated in the accumulator table, accumulator manager 718 adds the multiplied result of the received tuple to the corresponding entry of the accumulator table, and stores the updated value as the accumulated value in the corresponding entry of the accumulator table.

Accumulator storage 722 is a circuit that stores the accumulator table and the hash table. Accumulator storage 722 may be accessed by accumulator manager 718 and sorting circuit 726 to read and write data items. Accumulator storage 722 may be embodied as a dual-ported memory circuit (e.g., DPRAM), and more specifically, as a double buffer dual-ported memory circuit. By using the dual-ported memory circuit, both accumulator manager 718 and sorting circuit 726 may access accumulator storage 722 concurrently, as needed. Although accumulator storage 722 of each lane is illustrated in FIG. 7 as being separate circuits, a single memory circuit with distinct logical memory spaces may be used to embody accumulator storage 722 in multiple lanes 712.

Conceptually, each of accumulator manager 718 and accumulator storage 722 in each of lanes 712 processes and stores a part of a larger accumulator table and a larger hash table associated with the entire tuples of multiplied results 748 and weight indices 738. Without the use of multiple lanes 712, a single accumulator manager would be responsible for managing the large accumulator table and the large hash table for all tuples, which may result in a bottleneck at accumulation operations. By dividing the accumulator table and the hash table into smaller counterparts that are accessed and processed by respective lanes 712, the same accumulation operations may be performed more efficiently without causing the bottleneck. The ratio of the total number of tuples processed concurrently to the number of lanes may be determined by simulation or statistical analysis to prevent such bottlenecks.

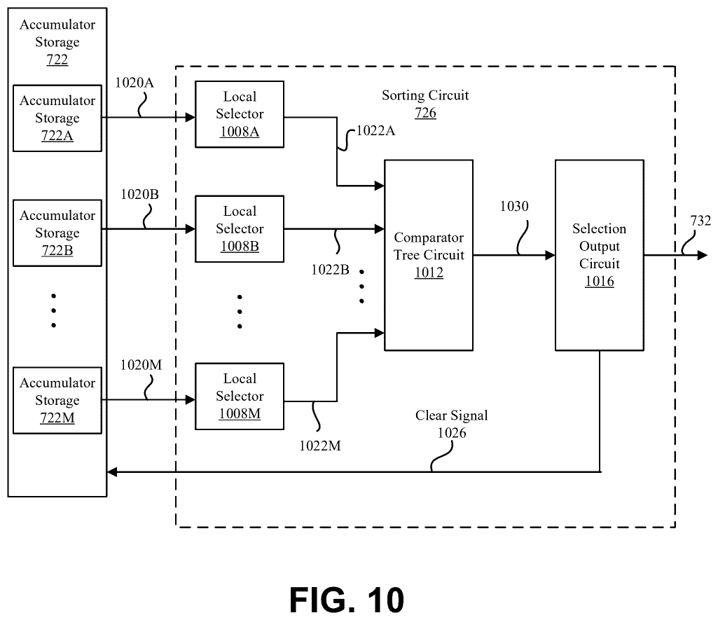

Sorting circuit 726 performs top-k operations on the accumulated results stored in accumulator storage 722 to select top-k values. Sorting circuit 726 may determine the highest accumulated result in accumulator storage 722 of each lane 712, and then compare these highest accumulated results of different lanes 712 to determine the highest accumulated results. k number of the highest accumulated results are then output from sorting circuit 726 as top-k value output 732 after the comparison operations are finished. Such comparison operations may be performed by sorting circuit 726 sequentially after the accumulation operations are finished at each lane 712, or at least partially in parallel with the accumulation operations at each lane. In some embodiments, by using a double buffer dual-port memory circuit as accumulator storage 722, a half of the dual-port memory circuit is accessed by accumulator manager 718 to perform the accumulation operations on multiplied results of a current input tensor while the other half of the same circuit is accessed by sorting circuit 726 to perform the sorting operation on the accumulated values of the prior input tensors. The details of sorting circuit 726 are described below with reference to FIG. 10.

FIG. 8 is a block diagram illustrating distributor circuit 708 of MAS circuit 624, according to an embodiment. Distributor circuit 708 may include, among others, mod circuit 804, state machine 806, first selection circuits 814A through 814M (hereinafter also referred to collectively as “first selection circuits 814” or individually as “first selection circuit 814”), collision detect circuit 818, collision buffer 824, second selection circuits 820A through 820M (hereinafter also referred to collectively as “second selection circuits 820” or individually as “second selection circuit 820”), and switch 830. One or more of these components may be combined with other components. Alternatively, one or more of these components may be omitted or replaced.

Mod M circuit 804 computes a deterministic hash from each of weight indices 738 and generates mod signal 812. For this purpose, mod M circuit 804 may use a module-M function on the weight indices 738 to generate mod signal 812. Mod signal 812 is used by circuits downstream of mod M circuit 804 to forward each of the tuples to one of lanes 712. Mod signal 812 may also be used to detect any collisions of the tuples. The number of elements (e.g., mod values) in mod signal 812 coincides with the number of tuples (e.g., G) concurrently received by distributor circuit 708. In other embodiments, mod M circuit 804 may be replaced with other circuits that perform different deterministic load balancing hash functions such as CRC-15 or MurmurHash.

First selection circuits 814 receive mod signal 812 and send match information 852 indicating which lane each of the tuples is to be distributed to. For this purpose, M number of first selection circuits 814 corresponding to the number of lanes operate in parallel to determine which lane numbers match mod values in mod signal 812. Match information 852 is generated as a result of the matching operations, and sent to switch 830 so that the tuples of multiplied results 748 and weight indices 738 are distributed to lanes 712.

### Example Collision Resolution Mechanism

During concurrent processing of a set of tuples, a collision may occur where two or more concurrent weight indices 738 are mapped to the same lane. In some embodiments, each of lanes 712 may receive only one tuple in a processing cycle, and hence, the remaining tuples may not be fed to the same lane in the same processing cycle. Taking an example where the number of incoming tuples G=8, and the number of lanes M=512, collisions will occur 5.35% of the time on average. In one or more embodiments, collision detect circuit 818, collision buffer 824, first selection circuits 814 and second selection circuits 820 operate in conjunction to address and handle such collisions, and thereby ensure continuous feeding of distributed tuples to lanes 712 without stalling by differing the times at which the colliding tuples are sent to lanes 712. However, other circuits and mechanisms may be used instead to detect and handle such collisions.

When there is a collision, first selection circuit 814 that handles the colliding tuples instructs switch 830 to push, in the current processing cycle, one of the colliding tuples to switch 830 according to a predetermined priority rule. The priority rule may indicate, for example, that the tuple associated with the lowest index number among the tuples be pushed to switch 830. For this purpose, match information 852 may indicate tuples as prioritized by first selection circuits 814 for feeding to lanes 712 in this processing cycle. The remaining colliding tuples may be stored in collision buffer 824, as instructed by collision detect circuit 818.

Collision detect circuit 818 detects the collision for addressing. Collision detect circuit 818 may perform pairwise equality comparisons between the mod values [0: G−1] in mod signal 812. If two or more of the mod values are identical, then a collision is identified. Once the collision is detected, collision detect circuit 818 instructs collision buffer 824 to store, in collision buffer 824, one or more colliding tuples not pushed to switch 830 by the first selection circuits 814 in this processing cycle. Collision detect circuit 818 applies a storing rule opposite to the priority rule used by the first selection circuits 814 to store the colliding tuples in collision buffer 824. For example, if the priority rule indicates that the tuple associated with the lowest index number is to be sent to switch 830 in this cycle, the storing rule indicates that any other tuples that have higher index numbers are to be stored in collision buffer 824.

Each of second selection circuits 820 is assigned to one of lanes 712 to feed colliding tuples in subsequent cycles when the assigned lane becomes available to receive the colliding tuples. That is, the colliding tuples stored in collision buffer 824 are sent to lanes 712 at subsequent processing cycles when their corresponding first selection circuits 814 are not pushing the prioritized tuples to lanes 712. Since the number of lanes (M) is larger than the number of concurrent tuples (G), only a subset of lanes 712 receives prioritized tuples from first selection circuits 814 in a processing cycle. When a lane is not receiving the prioritized tuples in the subsequent processing cycles, a second selection circuit corresponding to the lane instructs switch 830 to drain the colliding tuples 828 in collision buffer 824 to the subset of lanes 712, one per each processing cycle. In some embodiments, second selection circuits 820 may be omitted, and their functions are combined into first selection circuits 814. In such embodiments, first selection circuits 814 store information on colliding tuples in collision buffer 824, and instruct switch 830 to feed colliding tuples 828 from the collision buffer 824 in one or more subsequent cycles. In effect, the combination of first selection circuits 814, second selection circuits 820 and switch 830 functions as a crossbar that sends each of the tuples received at distributor circuit 708 to assigned lanes 712 at an appropriate timing.

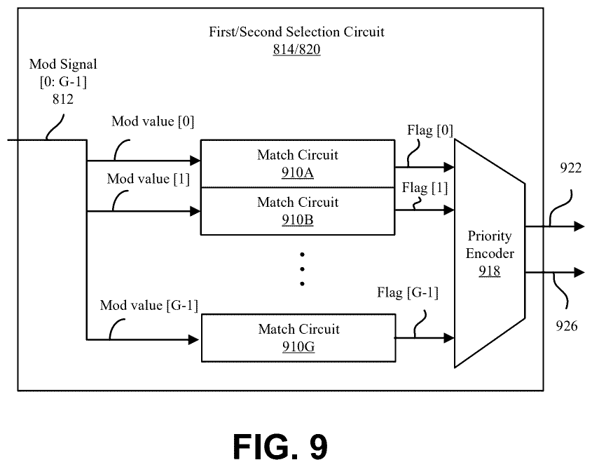

FIG. 9 is a block diagram of first selection circuits 814 and second selection circuits 820, according to an embodiment. Each of first selection circuits 814 and second selection circuits 820 is assigned to one of lanes 712 to detect if incoming tuples should be fed to its assigned lane via switch 830. For this purpose, each of first selection circuits 814 and second selection circuits 820 may include, among other components, match circuits 910A through 910G (hereinafter referred to collectively as “match circuits 910” and individually as “match circuit 910”), and priority encoder 918. The primary difference in first selection circuits 814 and second selection circuits 820 is whether they push prioritized tuples to lanes 712 in the current processing cycle or push colliding tuples in collision buffer 824 in subsequent processing cycles.

Each match circuit 910 determines whether the mod value that it receives matches the assigned lane number, and sends a flag indicating whether there is a match. Such matching operations are performed in parallel by G number of match circuits 910. The matching operation may be performed by comparing bits between the received mode value and the lane number. If more than one flag indicates a match, then there is a collision; if only one flag indicates a match, then there is no collision and one tuple is to be fed to the assigned lane by a corresponding first/second selection circuit in this current processing cycle; and if there is no flag that indicates a match, there is no tuple to be fed to the assigned lane by the corresponding first/second selection circuit in this processing cycle.

Priority encoder 918 receives flags from match circuits 910, and generates push signal 922 and select signal 926, as its match information 852. Push signal 922 indicates if there is any tuple to be fed to the assigned lane. If there is, select signal 926 indicates which of the tuples should be fed to the assigned lane. When there are multiple flags that match the lane number of the assigned lane, priority encoder 918 applies the priority rule to select only one tuple and sends select signal 926 indicating the selected tuple. Priority encoder 918 in second selection circuits 820 may prioritize one tuple over another when there are multiple tuples in collision buffer 824 to be pushed to the same lane.

### Example Sorting Circuit Architecture

FIG. 10 is a block diagram of sorting circuit 726 of MAS circuit 624, according to an embodiment. Sorting circuit 726 operates across multiple comparison cycles to determine k number of globally highest accumulated values in accumulator storage 722 of each lane 712 to include top-k accumulated values or its approximation in its output 732. During each comparison cycle, locally highest accumulated values in each lane 712 are extracted, comparisons are made between the locally highest accumulated values to extract a globally highest accumulated value, and the globally highest accumulated value is added to top-k accumulated values, and then the globally highest value is cleared or removed from the accumulated values stored in lanes 712. Then, sorting circuit 726 performs a subsequent comparison cycle to extract and add the next highest accumulated value from lanes 712 to the top-k accumulated values. The comparison cycles are repeated until k number of accumulated values are extracted. The indices of the top-k accumulated values are also tracked, and hence, output 732 includes the top-k accumulated values and their indices.

A comparison cycle of lanes 712 may be the same as a processing cycle of sorting circuit 726 or be different from the processing cycle. In one or more embodiments, the speed of the comparison cycle and the processing cycle are set so that neither the accumulation operations nor the comparison operations are stalled or delayed due to filling up of buffers 714 in lanes 712 or starvation of output from lanes 712, while reducing unnecessary power consumption.

For this purpose, sorting circuit 726 may include, among other components, local selectors 1008A through 1008M (hereinafter referred to collectively as “local selectors 1008” and also individually as “local selector 1008”), comparator tree circuit 1012, and selection output circuit 1016. Sorting circuit 726 may include other circuits or combine some of these components into a single circuit.

Local selectors 1008 receive sets of lane tuples 1020A through 1020M (hereinafter referred to collectively as “lane tuples 1020” and also individually as “lane tuple 1020”), determine highest lane tuples 1022A through 1022M (hereinafter referred to collectively as “highest lane tuples 1022” or individually as “highest lane tuple 1022”), and send the highest lane tuples 1022 to comparator tree circuit 1012, in a comparison cycle. Lane tuple 1020 refers to accumulated values stored in a lane as a result of an accumulation operation, and their corresponding indices. Highest lane tuple 1022 refers to one of remaining lane tuples 1020 that includes the highest accumulated value in the current comparison cycle, and its corresponding index.

Comparator tree circuit 1012 receives highest lane tuples 1022 from all lanes, and compares them to determine a max tuple 1030 that includes the globally highest accumulated value in the current comparison cycle. Max tuple 1030 is sent to selection output circuit 1016 so that max tuple 1030 may be added to output 732. Selection output circuit 1016 also sends clear signal 1026 indicating max tuple 1030 so that it can be removed from the comparison operations in subsequent comparison cycles. That is, max tuple 1030 in a current comparison cycle is cleared from accumulator storage 722 so that local tuples 1020 other than max tuple 1030 are compared by local selector 1008 and comparator tree circuit 1012 in the subsequent comparison cycles. The comparison cycles are repeated until k number of max tuples 1030 are obtained.

Selection output circuit 1016 collects max tuples 1030 over multiple comparison cycles covering the entire weight tensor and the entire activation tensor, and sends output 732 that includes k number of max tuples 1030 in a compressed sparse format for processing in the next layer or circuit. When entire multiplied results 748 are accumulated into entries in accumulator storage 722 and the comparison cycles are performed after all accumulator operations of activations 730 are complete, then output 732 of selection output circuit 1016 includes accurate top-k tuples. However, if only a subset of multiplied results 748 are processed, for example, due to the limited number of accumulator entries or only a part of the comparison cycles is performed, then output 732 of selection output circuit 1016 may include tuples that approximate top-k tuples. Depending on resource constraints or processing time, MAS circuit 624 may produce approximate top-K tuples instead of accurate top-K tuples.

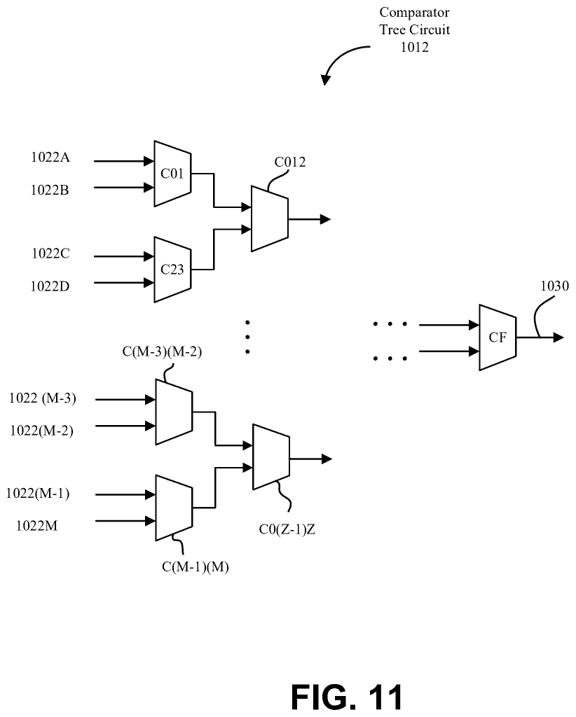

FIG. 11 is a block diagram of comparator tree circuit 1012, according to an embodiment. Comparator tree circuit 1012 may include, among other components, multiple levels of comparators. Each of the first level of comparators C01, C23, . . . C(M−3)(M−2), C0(M−1) (M) receives two highest lane tuples 1022 from two local selectors 1008, compares the accumulated values of the received highest lane tuples to select a tuple with a higher accumulated value, and passes on the selected tuple to a second level of comparators C012, . . . C(Z−1)Z. The second level of comparators C012, . . . C(Z−1)Z compares the selected tuples from the first level of comparators and then performs the subsequent comparison to select the higher tuples from its input tuples. The next levels of comparators perform the comparison operations until last comparator CF determines and outputs max tuple 1030.

### Modified Example Multiply-Accumulate-Sort Circuit

Lanes 712 of MAS circuit 624 may be modified to obviate hash tables and instead use accumulator tables that have entries predesignated to store accumulator values associated with weight indices 738. Instead of accumulator manager 718 selectively instantiating entries in accumulator storage 722 for sparse weight indices 738 of non-zero weight values as they are received, accumulator storage 722 in each lane has predesignated entries to store accumulated values for all weight indices that may appear in the lane. In other words, accumulator storage 722 has a sufficient number of entries to store not only accumulated values for weight indices that have non-zero weight values, but also accumulated values for weight indices that have zero weight values.

In such embodiment, operations associated with the hash tables (e.g., searching and retrieving operations associated with hash tables) are omitted. Omission of such operations simplifies the accumulation operations by accumulator manager 718 and retrieval operations of sorting circuit 726, enabling the accumulation operations to be completed in fewer processing cycles compared to the embodiments described above with reference to FIG. 7. When the results of performing tensor operations between sparse weights and sparse activations result in a dense output, this alternative embodiment may increase the processing performance without significantly increasing the memory space in accumulator storage 722 relative to the embodiments described above with reference to FIG. 7.

### Example Method of Operating MAS Circuit

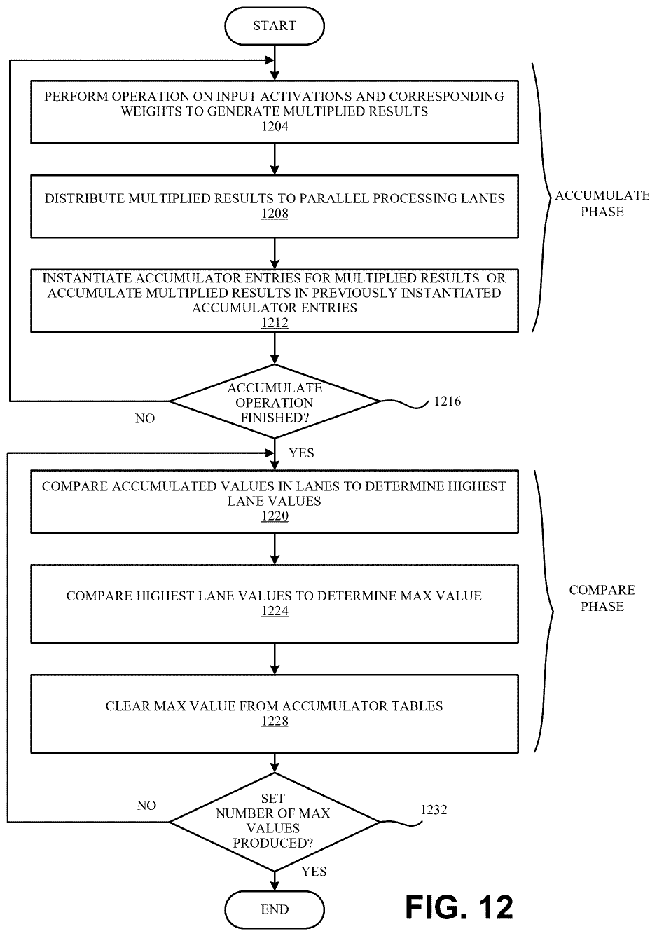

FIG. 12 is a flowchart illustrating the processes of operating MAS circuit 624, according to an embodiment. MAS circuit 624 operates in two phases: an accumulate phase and a compare phase. During the accumulate phase, MAS circuit 624 performs accumulation operations to accumulate multiplied results into accumulator tables in multiple lanes. In the compare phase, MAS circuit 624 compares the accumulated values in the accumulator tables to determine top-k accumulated values, and outputs these values. The compare phase for a set of tuples may follow the accumulate phase for the same set of tuples. In some embodiments, the two phases may overlap. That is, the accumulation operations are performed on one set of tuples while the compare operations are performed on another set of inputs.

In the accumulate phase, multiplication circuits 704 perform 1204 operations (e.g., multiplications) on activations 730 and weights 734 or parts thereof to generate multiplied results. The multiplied results are then distributed 1208 to parallel processing lanes. In some embodiments, the multiplied results may be included in tuples that also include the indices (e.g., weight indices) associated with the weights. The tuples are then distributed to a subset of multiple parallel processing lanes in a processing cycle. Where there is a collision, a subset of the tuples may be distributed to the parallel processing lanes in subsequent processing cycles.

In each lane, accumulator entries are instantiated 1212 in an accumulator table or the accumulated values in previously instantiated accumulator entries are updated to add the multiplied results. For this purpose, a hash table associated with each lane may be updated or searched. In embodiments where the hash table is omitted, the instantiation of accumulator entries may be omitted, and the results may be added with accumulated values in predesignated accumulator entries of an accumulator table. Such operation is performed in parallel across multiple lanes so that all the results from the concurrently received activations and weights are processed.

Then it is determined 1216 if the accumulate operation is finished. For example, it is determined if all activations and weights for a time step have undergone the accumulation operations. If not, the process returns to performing 1204 operations on a subsequent part of activations and weights, and repeats the subsequent processes. If it is determined that all the activations and weights are accumulated, then the process proceeds to the compare phase for the accumulated values.

In the compare phase, all accumulated values in each lane are compared 1220 with each other to determine the highest lane value in a comparison cycle. The highest lane values of each lane are then compared 1224 to determine the max value in that comparison cycle. The max value is included in the output of MAS circuit 624. The max value is cleared 1228 from the accumulator tables.

It is then determined 1232 if a set number (e.g., k) of max values has been produced. If not, the process returns to compare 1220 the remaining accumulated values in lanes to determine the highest lane values, with the prior max value removed from comparison, and repeats the subsequent processes. Conversely, if it is determined that the set number of max values has been produced, the process terminates.

The processes and their sequences described above with reference to FIG. 12 are merely illustrative and various modifications may be made. For example, the comparison phase may start before the accumulate phase is fully finished.

### ALTERNATIVE EMBODIMENTS

In alternative embodiments, part of the processes performed by the MAS circuit may be performed by a generic processor. For example, instead of performing the compare phase by the MAS circuit, all the operations in the compare phase may be performed by a CPU or a GPU.

In other embodiments, the crossbar of FIG. 8 including first selection circuits 814, second selection circuit 820 and switch 830 is replaced with other circuits. These replacement circuits, for example, may be embodied using pass gates or multiplexers. These circuits may have various architecture, and in some cases, may include additional functionality.

In other embodiments, activations are Boolean and indices 738 indicate which of the corresponding activations are non-zero. In such cases, circuits to perform Boolean operations replaces multiplication circuits 704 of FIG. 7, and indices 738 are fed to these circuits instead of activations.

Upon reading this disclosure, those of skill in the art will appreciate still additional alternative designs for processing nodes. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A device for performing operations on tensors, comprising:
a plurality of operation circuits configured to perform first operations on a first tensor and a second tensor to generate first operation values;
a distributor circuit coupled to the plurality of operation circuits, the distributor circuit configured to:
receive the first operation values, and
distribute the first operation values in a deterministic manner; and
a plurality of parallel processing circuits coupled to the distributor circuit, each of the parallel processing circuits configured to:
receive a subset of the first operation values as distributed by the distributor circuit, and
perform second operations on the subset of the first operation values to generate second operation values.

2. The device of claim 1, wherein the first tensor comprises a sparse activation tensor, and the second tensor comprises a sparse weight tensor, and wherein the first operations comprise multiplications and the second operations comprise accumulations.

3. The device of claim 2, wherein a number of the plurality of parallel processing circuits is larger than a number of the plurality of operation circuits.

4. The device of claim 1, wherein the distributor circuit is further configured to:
receive indices indicating elements of the second tensor from which the first operation values are derived,
select one of the parallel processing circuits to perform the second operations on each of the first operation values according to an index associated with each of the first operation values, and
distribute each of the first operation values and the associated index to the selected one of the parallel processing circuits as a tuple.

5. The device of claim 4, wherein each of the plurality of parallel processing circuits comprises:
a buffer to store the subset of the first operation values distributed to each of the plurality of parallel processing circuits;
a manager circuit configured to read the subset of the first operation values from the buffer, and perform the second operations on the subset of the first operation values; and
a storage circuit configured to store an operation table that stores the second operation values derived from the subset of the first operation values associated with a same index.

6. The device of claim 5, wherein the manager circuit is further configured to:
determine if the operation table has space to accommodate an additional second operation value;
in response to determining that the operation table has the space, instantiate an entry in the operation table to store the additional second operation value; and
in response to determining that the operation table lacks the space, skip storage of the additional second operation value in the operation table.

7. The device of claim 5, wherein the storage circuit further stores a hash table that stores indices associated with the second operation values as keys.

8. The device of claim 1, further comprising a sorting circuit coupled to the plurality of parallel processing circuits, and configured to:
determine a globally highest second operation value of the second operation values in the plurality of parallel processing circuits in a first comparison cycle;
clear the globally highest second operation value from the plurality of parallel processing circuits; and
determine a next globally highest second operation value of the second operation values in the plurality of parallel processing circuits in a second comparison cycle after clearing the first globally highest second operation value.

9. The device of claim 8, wherein the sorting circuit comprises:
a plurality of selector circuits configured to determine locally highest second operation values in each of the plurality of parallel processing circuits; and
a comparator tree circuit configured to compare the locally highest second operation values to determine the globally highest second operation value and the next globally highest second operation value.

10. The device of claim 8, further comprising an output circuit configured to output a sparse tensor in a compressed format that includes a predetermined number of tuples including globally highest second values and indices associated with the globally highest second values.

11. The device of claim 1, wherein the distributor circuit is configured to resolve collisions of assigning two or more first operation values concurrently processed by the plurality of operation circuits to a same one of the parallel processing circuits by differing times at which the two or more first operation values are sent to the same one of the parallel processing circuits.

12. A method for performing operations on tensors, comprising:
performing, by operation circuits, first operations on a first tensor and a second tensor to generate first operation values;
distributing, by a distributor circuit, the first operation values in a deterministic manner to parallel processing circuits; and
performing second operations, by parallel processing circuits, on the first operation values in parallel to generate second operation values.

13. The method of claim 12, wherein the first tensor comprises a sparse activation tensor, and the second tensor comprises a sparse weight tensor, and wherein the first operations comprise multiplications and the second operations comprise accumulations.

14. The method of claim 13, wherein a number of the parallel processing circuits is larger than a number of the operation circuits.

15. The method of claim 12, wherein distributing the first operation values comprises:
receiving indices indicating elements of the second tensor from which the first operation values are derived,
selecting, by the distributor circuit, one of the parallel processing circuits to perform the second operations on each of the first operation values according to an index associated with each of the first operation values, and
distributing each of the first operation values and the associated index to the selected one of the parallel processing circuits as a tuple.

16. The method of claim 15, wherein performing the second operations comprises:
storing, in a buffer of each of the parallel processing circuits, the first operation values distributed to each of the parallel processing circuits;
reading the first operation values from the buffer to perform the second operations on the first operation values; and
storing an operation table that stores the second operation values derived from the first operation values associated with a same index.

17. The method of claim 16, wherein performing the second operations further comprises:
determining if the operation table has space to accommodate an additional second operation value;
in response to determining that the operation table has the space, instantiating an entry in the operation table to store the additional second operation value; and
in response to determining that the operation table lacks the space, skipping storage of the additional second operation value in the operation table.

18. The method of claim 17, wherein performing the second operations further comprises storing a hash table that stores indices associated with the second operation values as keys.

19. The method of claim 12, further comprising:
determining, by a sorting circuit, a globally highest second operation value of the second operation values in the parallel processing circuits in a first comparison cycle;
clearing the globally highest second operation value from the parallel processing circuits; and
determining a next globally highest second operation value of the second operation values in the parallel processing circuits in a second comparison cycle after clearing the first globally highest second operation value.

20. The method of claim 19, wherein determining the globally highest second operation value comprises:
determining locally highest second operation values in each of the parallel processing circuits; and
comparing the locally highest second operation values to determine the globally highest second operation value and the next globally highest second operation value.
